(19) United States
(12) Patent Application Publication
(10) Pub. No.: US 2006/0080484 A1
(43) Pub. Date: Apr. 13, 2006

(54) System having a module adapted to be included in the system in place of a processor

(76) Inventors: Joel P. Lefebvre, Fort Collins, CO (US); Raphael Gay, Fort Collins, CO (US); Stephen G. Uhlmann, Loveland, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/960,530

(22) Filed: Oct. 7, 2004

(51) Int. Cl. G06F 13/00

(52) U.S. Cl. 710/104

(57) ABSTRACT

A system comprises a plurality of processor sockets and a module adapted to be received into at least one of the processor sockets in place of a processor. The sockets are electrically connected by way of communication links. Each socket has a plurality of electrical contacts electrically connected to the communication links. The module has electrical contacts that electrically mate with the contacts of the socket to thereby electrically connect together at least two of the communication links.

### BACKGROUND

Many system boards are designed to accommodate two or more processors. Multi-processor systems are generally capable of higher performance than single-processor systems. In some multi-processor systems, each processor may couple to another processor, to an input/output (“I/O”) controller, and/or to another type of device. Those processors that connect to an I/O controller are included in the system to provide access to the I/O controller and any I/O device(s) connected to the I/O controller. For example, a two processor system must have each processor installed and operational to permit access to an I/O controller that may be connected to each processor. Such a system provides little or no flexibility in terms of the number of processors that are installed.

### BRIEF SUMMARY

In accordance with at least some embodiments of the invention, a system comprises a plurality of processor sockets and a module adapted to be received into at least one of the processor sockets in place of a processor. The sockets are electrically connected by way of communication links. Each socket has a plurality of electrical contacts electrically connected to the communication links. The module has electrical contacts that electrically mate with the contacts of the socket to thereby electrically connect together at least two of the communication links.

### BRIEF DESCRIPTION OF THE DRAWINGS

For a detailed description of exemplary embodiments of the invention, reference will now be made to the accompanying drawings in which:

FIG. 1 shows a two-processor system in which embodiments of the invention may be implemented;

FIG. 2 shows a two-processor-capable system in which an accessory module is installed in place of one of the processors;

FIG. 3 shows an embodiment of an accessory module; and

FIG. 4 shows a four-processor-capable system in which an accessory module is installed in place of one of the processors.

### NOTATION AND NOMENCLATURE

Certain terms are used throughout the following description and claims to refer to particular system components. As one skilled in the art will appreciate, computer companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . .” Also, the term “couple” or “couples” is intended to mean either an indirect or direct electrical connection. Thus, if a first device couples to a second device, that connection may be through a direct electrical connection, or through an indirect electrical connection via other devices and connections. The term “system” refers to a collection of two or more parts and may be used to refer to a computer system or a portion of a computer system.

### DETAILED DESCRIPTION

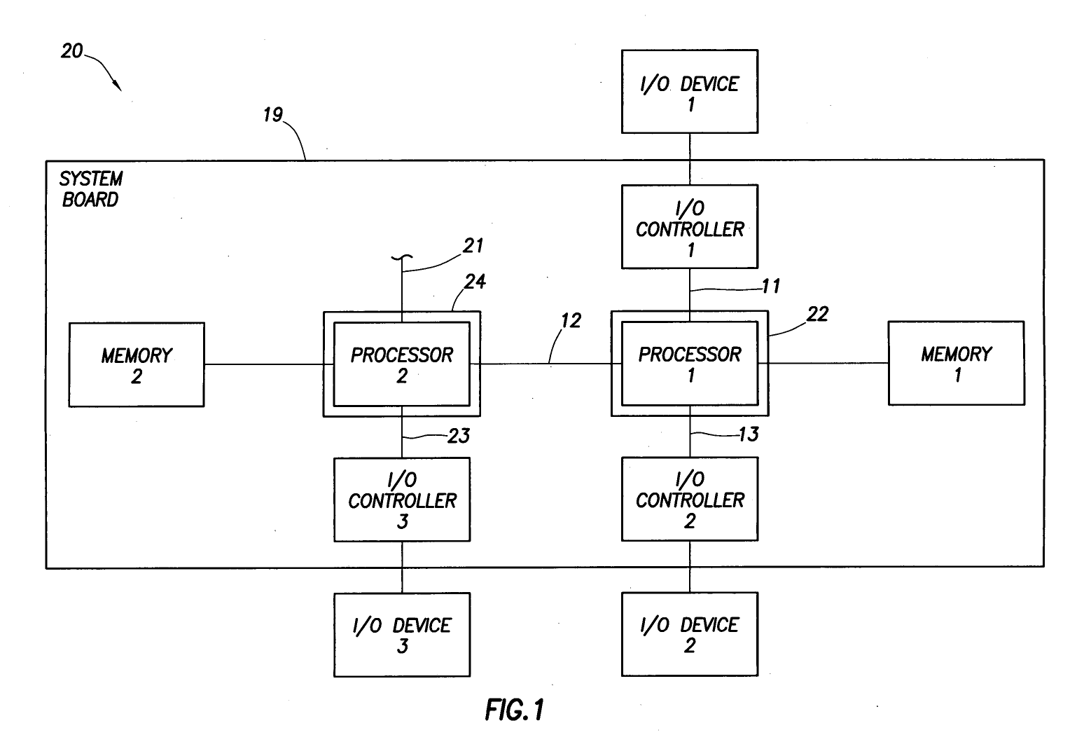

FIG. 1 shows an embodiment of a multi-processor system 20. System 20 includes a system board 19 on which a plurality of components are installed. Such components include two processors labeled as “processor 1” and “processor 2” coupled together by a communication link 12. Other links (e.g., links 11, 13, 21, 22, 23) are also shown connecting together the various components. The processors 1 and 2 and other devices shown in FIG. 1 communicate with one another by way of the communication links. Each link depicted in FIG. 1 comprises one or more signals by which the components communicate with each other. In the embodiments of FIGS. 1, 2 and 4, each processor has four electrical interfaces, although in other embodiments, a different number of interfaces (i.e., more or less than four) can be provided for each processor. One interface is to external memory—processor 1 couples to memory 1 and processor 2 couples to memory 2. Each processor has three other electrical interfaces that can couple the processor to another processor or to an input/output (“I/O”) controller. Processors 1 and 2 couple together via link 12 as noted above. Further, processor 1 couples to I/O controller 1 via a link 11 and to an I/O controller 2 via a link 13. Processor 2 couples to an I/O controller 3 via a link 23. While another I/O controller could be included in system 20 to couple to processor 2, no such controller is provided in the example of FIG. 1. Links are also included, although not labeled with reference numerals, between the processors and associated memories.

Each I/O controller is adapted to couple to one or more I/O devices. As shown, I/O controllers 1, 2 and 3 couple to I/O devices 1, 2, and 3, respectively. Each I/O device may comprise any desired type of device. Examples of I/O devices include storage devices, printers, pointer devices (e.g., a mouse), and a display.

Each processor is adapted to be installed into a socket in system 20. As shown, processor 1 is installed in socket 22 and processor 2 is installed in socket 24. The sockets permit the processors to be removed and replaced. Each socket has a plurality of electrical contacts that mate with, or are otherwise associated with, corresponding electrical contacts on the processor installed in that socket. Each socket also has electrical contacts (which can be the same as noted above) that electrically connect to the communication links associated with the socket. By way of the communication links, the sockets are electrically coupled together and to other devices as shown. The sockets permit a single system board 19 design to be produced and one or both processor sockets 22, 24 can be populated with a processor as desired. Thus, if a system having two processors is desired, each socket can be populated with a processor. If, instead, a system having only one processor is desired, only one of the sockets need be populated with a processor. A user may desire to initially populate system board 19 with a single processor, but later add a second processor. The embodiment of FIG. 1 provides flexibility regarding the inclusion of processors in the system.

If processor 2 is removed or otherwise not installed in system 20, access by other components in the system (e.g., processor 1) to I/O controller 3 or memory 2 will be precluded. Consequently, without processor 2 any I/O device(s) coupled to I//O controller 3 will be inaccessible to other components in the system 20.

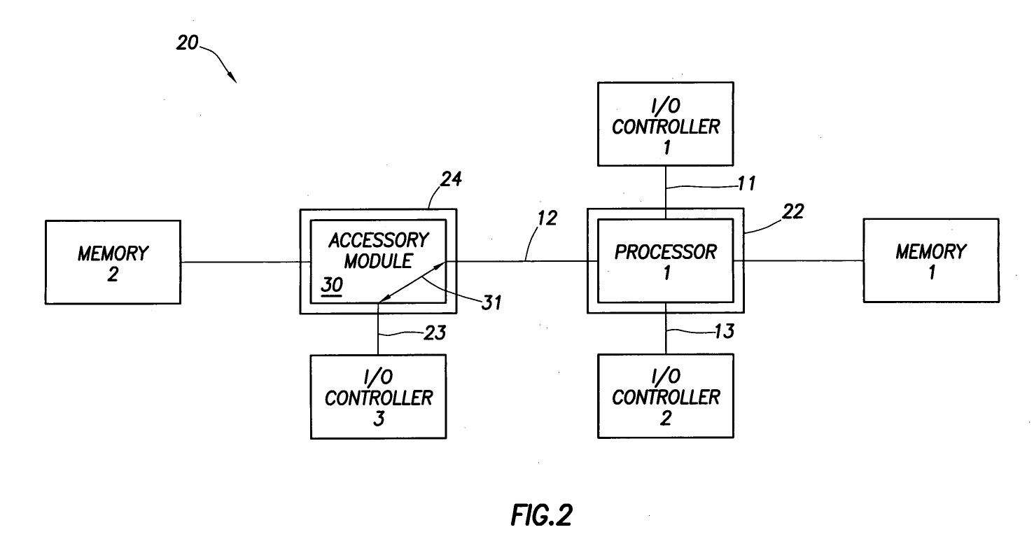

FIG. 2 illustrates system 20 in which an accessory module 30 has been installed in one of the sockets (socket 22) instead of a processor. The accessory module 30 may be installed in socket 22 at the factory. Alternatively, an operator of system 20 may remove processor 2 (if processor 2 was installed) on install the accessory module 30 himself or herself. Accessory module 30 may be installed in either of the processor sockets 22 or 24. As noted above, each processor includes an electrical connection mechanism for connection to the socket. For example, each processor may include a plurality of conductive contacts (e.g., pins) that, upon installation of the processor into the socket, electrically connect to corresponding conductive contacts (receptacles) in the socket. The accessory module 30 includes the same type of electrical connection mechanism as the processors to connect to the socket.

Accessory module 30 functions to electrically connect a pair of communication links that would otherwise connect to a processor if such a processor were installed in the socket in place of the accessory module. In the example of FIG. 2, the accessory module 30 connects link 12 to link 23 (as depicted by arrow 31), thereby providing a direct electrical connection between processor 1 and I/O controller 3. As such, I/O controller 3 and any I/O devices connected thereto are still accessible and usable by the system 20.

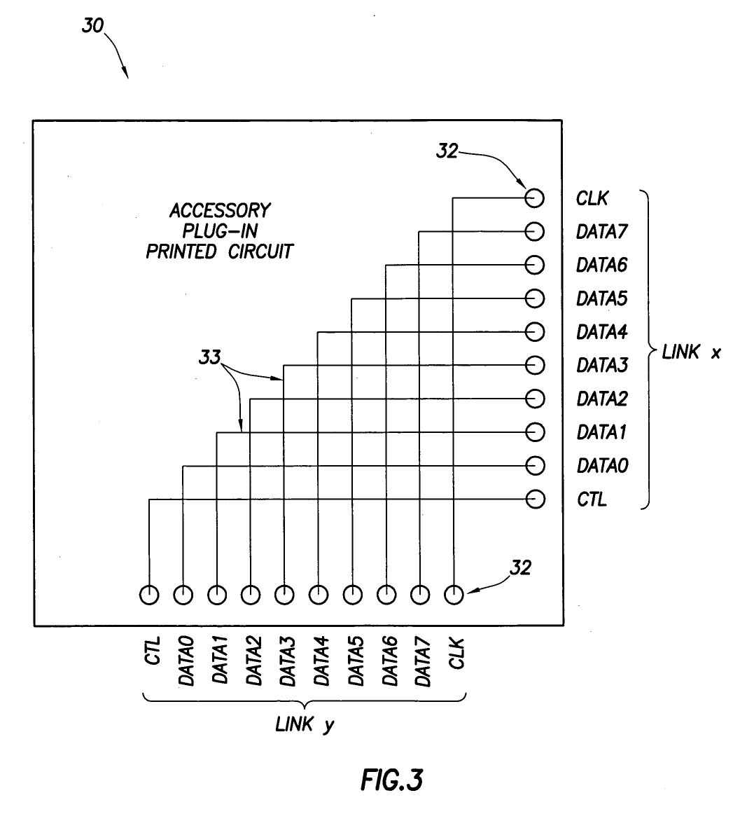

The signal definitions of the communication links can be in accordance with any suitable protocol. At least some protocols have data, address, clock, and control signals. FIG. 3 shows an embodiment of an accessory module 30 in which at least some of the signals from a link x are electrically connected to the corresponding signals of a link y. As such, common signals among separate links are connected together. The signals shown include a clock signal (“CLK”), data signals (DATA0 through DATA7) and a control signal (“CTL”). The CLK signal of link x electrically connects to the CLK signal of link y. Similarly, the DATA7 signal of link x electrically connects to the DATA7 signal of link y, and so on. Different, fewer, or additional signals may be electrically connected together via the accessory module 30.

Referring still to FIG. 3, the accessory module 30 may electrically connect corresponding signals of two links via electrical contacts 32 and electrical pathways 33. In some embodiments, the accessory module 30 comprises a circuit board having electrical pathways such as conductive traces formed using suitable manufacturing techniques on a conductive layer of the board. In other embodiments, the accessory module 30 comprise wires soldered in place on a circuit board so as to interconnect the signals as desired. The electrical pathways in at least some embodiments do not include any active electrical components, such as would be the case for bridge chips and the like. Further, the accessory module 30 need not be a circuit board, but may comprise any type of mechanical structure that can be installed in a processor socket to electrically interconnect corresponding signals between two of the communication links. In general, the accessory module 30 has electrical contacts that electrically mate with the electrical contacts of the socket to thereby electrically connect together at least two of the communication links.

Each processor depicted in FIGS. 1 and 2 comprises interfaces to four links, although in other embodiments as noted above, the number of processor links can be different than four (i.e., fewer or more than four). The accessory module 30 can be configured to interconnect any pair of links. As noted above, FIG. 2 shows the accessory module interconnecting links 12 and 23 to connect the processor 1 to the I/O controller 3. Alternatively, accessory module 30 could be configured to interconnect link 12 to the memory 2 thereby permitting processor 1 to access memory 2. This is especially true if the link to the memories is of the same type as the inter-processor links and links between processors and I/O controllers. Further still, either of links 23 or 12 could be connected to link 21 through the accessory module, although, in the particular embodiment of FIG. 2 without a device connected to link 21, there would be little, if any, reason for providing such an accessory module. Similarly, the accessory module 30 could be configured to connect either of links 21 or 23 to memory 2. Any pair of links can be connected in this manner in accordance with the desires of the system designer or operator. In some embodiments, the communication links interconnecting the sockets and connecting the sockets to the I/O controllers are the same and thus the accessory module can be configured to bridge together those links. However, the communication links connecting the sockets to the memory devices may be different. The accessory module 30 may not be configurable to interconnect disparate communication links and thus not suitable for bridging together, for example, link 12 to memory 2. In other embodiments, the communication links to the memory devices are the same as the other communication links between the sockets and to/from the I/O controllers. As such, the accessory module 30 may be suitable for bridging together any pair of links as noted above, including links to the memory devices.

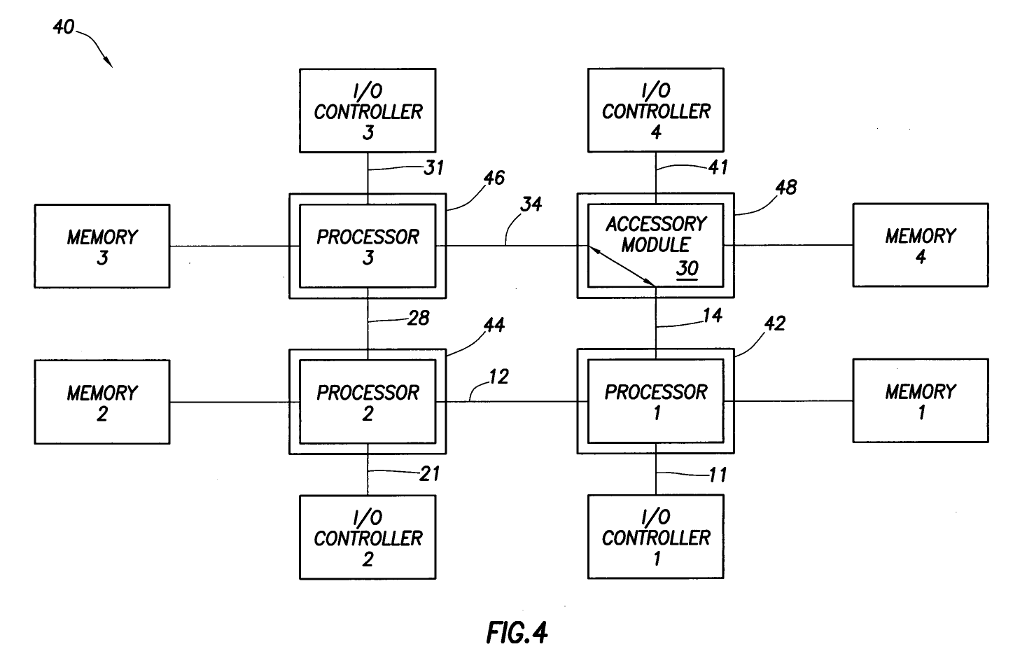

FIG. 4 shows a four-processor embodiment of a system 40. The system comprises processors 1, 2, and 3 installed in sockets 42, 44, and 46, respectively. Each of the processors is shown connected to a memory and an I/O controller. Thus, processor 1 connects to memory 1 and I/O controller 1. Similarly, processors 2 and 3 connect to memories 2 and 3, respectively, and to I/O controllers 2 and 3, respectively. Processor 1 connects to processor 2 via link 21. Processor 2 connects to processor 3 via link 28. A fourth socket, socket 48, is also included in which a processor could be installed. In the example of FIG. 4, an accessory module 30 is installed in socket 48 instead of what would have been a processor 4. Socket 48 electrically connects to links 14, 34, 41 and to memory 4.

The accessory module 30 in the example of FIG. 4 interconnects links 14 and 34 to thereby electrically connecting together processors 1 and 3. In this way, communications between processors 1 and 3 can pass through processor 2 if desired, or directly, and thus with less latency, between processors 1 and 3 via accessory module 30. Also, with two communication paths between processors 1 and 3 (one path via processor 2 and the other path via the accessory module 30), bandwidth is increased between processors 1 and 3 relative to a system that has an unpopulated socket 48 (i.e., a system without an accessory module). As such, a system operator that, for whatever reason, does not wish to populate processor socket 48 with a processor can populate the socket with an accessory module and thereby improve the performance of the system.

As noted above, an accessory module can electrically connect together any desired pair of links. Referring still to the four-processor example of FIG. 4, accessory module 30 can be configured to bridge together link 41 (to I/O controller 4) to either of link 34 or link 14. Such an arrangement permits the system 40 to access the I/O controller 4 and thus any I/O devices connected thereto. For example, if accessory module 30 electrically connects together link 34 to link 41, processor 3 can access the I/O controller 4 via the electrical conduction pathways on the accessory module. Alternatively, accessory module 30 can be configured to electrically connect links 14 and 41 to permit access to I/O controller 4 via processor 1. As such, an omission of a processor in socket 48 does not render useless the attached I/O controller (i.e., I/O controller 4).

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1. A system, comprising:
a plurality of processor sockets electrically coupled by way of communication links, each socket adapted to receive a processor adapted to communicate with other devices in said system via communication links, and each socket has a plurality of electrical contacts electrically connected to said communication links; and
a module adapted to be received into at least one of said processor sockets in place of a processor, the module has electrical contacts that electrically mate with the electrical contacts of the socket to thereby electrically connect together at least two of said communication links.

2. The system of claim 1 wherein at least two of the other devices comprise other processors, and wherein the module is adapted to electrically connect together communication links to such other processors.

3. The system of claim 1 wherein at least two of the other devices comprise a separate processor and an input/output (“I/O”) controller, and wherein the module is adapted to electrically connect together communication links to said separate processor and said I/O controller.

4. The system of claim 1 wherein at least two of the other devices comprise a separate processor and an input/output (“I/O”) device, and wherein the module is adapted to electrically connect together communication links to said separate processor and said I/O device.

5. The system of claim 4 wherein the I/O device comprises a device selected from a group consisting of a storage device, a printer, a display, and a pointing device.

6. The system of claim 1 wherein the module comprises a circuit board having traces or wires provided on or in said circuit board to electrically connect together the communication links.

7. The system of claim 1 wherein the communication links have common signals and the module electrically connects together the common signals between the communication links.

8. The system of claim 1 wherein said other devices include a memory device electrically connected to the socket containing said module, and said module is adapted to electrically connect together another processor and the memory device.

9. An apparatus, comprising:
a circuit board having a plurality of electrical contacts; and
a plurality of electrical pathways, each pathway electrically connecting pairs of electrical contacts;
wherein the apparatus is adapted to reside on a system board in place of a processor.

10. The apparatus of claim 9 wherein the apparatus bridges together links to other devices with which the processor would otherwise communicate.

11. The apparatus of claim 9 wherein the apparatus bridges together links to at least another processor.

12. The apparatus of claim 9 wherein the electrical pathways comprise traces on said circuit board.

13. The apparatus of claim 12 wherein said circuit board does not comprise any active electronic components.

14. A system, comprising:
means for receiving a plurality of processors; and
means for electrically connecting together links to devices with which an absent processor would otherwise connect.

15. The system of claim 14 wherein the means for electrically connecting is also a means for electrically connecting links to other devices that comprise at least one input/output controller.
